(19) United States
(12) Patent Application Publication
(10) Pub. No.: US 2025/0122742 A1
(43) Pub. Date: Apr. 17, 2025

(54) CONTROL METHOD OF SWIMMING POOL CLEANING DEVICE AND DEVICE THEREOF

(71) Applicant: Aiper Global Pte. Ltd., Singapore (SG)

(72) Inventor: Qi Huang, Suzhou (CN)

(73) Assignee: Aiper Global Pte. Ltd., Singapore (SG)

(21) Appl. No.: 18/989,532

(22) Filed: Dec. 20, 2024

(30) Foreign Application Priority Data
Sep. 6, 2024 (CN) 2024112501546

(51) Int. Cl. E04H 4/16

(52) U.S. Cl. CPC E04H 4/1654

(57) ABSTRACT

A control method of a swimming pool cleaning device and a device are disclosed. The method comprises monitoring whether the swimming pool cleaning robot traveling on a first wall is close to an obstacle; if the swimming pool cleaning robot is close to the obstacle, controlling the robot to descend to a bottom of the pool; controlling the robot to move from the bottom of the pool towards a second wall and climb the second wall; wherein the robot is approaching the obstacle in a process of moving from the bottom of the pool towards the second wall and climbing the second wall. In the present disclosure, the second position on the second wall is taken as the starting point for the cleaning device to move forward, and the second position is closer to the first wall than the starting point on the second wall used in the prior art.

### FIELD OF THE INVENTION

The present disclosure relates to the field of swimming pool cleaning robot technology, more particularly to a control method of a swimming pool cleaning robot and a device thereof.

### BACKGROUND OF THE INVENTION

In recent years, with advances in science and technology and developments of Internet, robot technology has become increasingly sophisticated and been extensively applied in various fields of life. A variety of robots with dedicated purposes are flooding into the market, wherein swimming pool cleaning robots undertake a large number of cleaning tasks for users, which is of great assistance. The swimming pool cleaning robots clean foreign matters, such as slit, dirt and algae, on the bottoms and side walls of swimming pools to keep the swimming pools clean.

In a case where a swimming pool cleaning robot is cleaning side walls, on account of the size of the robot per se and the restriction over turn radius, it is required to reserve a sufficient space for the robot to make a turn when it switches to clean another wall. According to the previous straight-line wall cleaning path, it is likely to miss sweeping the regions near the junction between one wall and another wall. This may lower the cleaning coverage rate and is unfavorable to user visual presentation.

Hence, there is an urgent need for a path planning method capable of solving the cleaning problem of the missed regions.

### SUMMARY OF THE INVENTION

For the technical problem to be solved, the present disclosure intends to provide a control method of a swimming pool cleaning robot and a device, which can clean regions near the junction of two walls and enhance the corresponding cleaning coverage capacity.

In a first aspect, the present disclosure provides a control method of a swimming pool cleaning device, comprising:
monitoring whether the swimming pool cleaning robot traveling on a first wall is close to an obstacle;
if the swimming pool cleaning robot is close to the obstacle, controlling the robot to descend to a bottom of the pool;
controlling the robot to move from the bottom of the pool towards a second wall and climb the second wall;
wherein the robot is approaching the obstacle in a process of moving from the bottom of the pool towards the second wall and climbing the second wall.

In a second aspect, the present disclosure also provides a computer-readable storage medium.

The computer-readable storage medium is stored with computer programs, wherein the computer programs, when executed by a processor, implement the control method of the swimming pool cleaning device according to the first aspect.

In a third aspect, the present disclosure also provides a swimming pool cleaning device, comprising: one or more processors; and a memory for storing one or more programs.

The one or more programs, when executed by the one or more processors, cause the one or more processors to implement the control method of the swimming pool cleaning device according to the first aspect.

The advantageous effects of the present disclosure include: the cleaning device is controlled to move to a starting point of a cleaning task of the second wall, which is a point closer to the first wall than a starting point of a cleaning task in the prior art, so as to cover more regions during the cleaning task, reduce the sweep missing regions and enhance the cleaning coverage rate.

### BRIEF DESCRIPTION OF THE DRAWINGS

FIG. 1 illustrates a schematic diagram of a cleaning device on a first wall provided by the present disclosure;

FIG. 2 illustrates a schematic diagram of a cleaning device on a bottom surface provided by the present disclosure;

FIG. 3 illustrates a schematic diagram of a cleaning device turning on the bottom surface provided by the present disclosure;

FIG. 4 illustrates a schematic diagram of path planning of a cleaning device provided by an embodiment of the present disclosure;

FIG. 5 illustrates a schematic diagram of path planning of a cleaning device provided by another embodiment of the present disclosure;

FIG. 6 illustrates a schematic diagram of a cleaning path on a second wall provided by an embodiment of the present disclosure;

FIG. 7 illustrates a schematic diagram of a cleaning path on a second wall provided by another embodiment of the present disclosure.

### SIGN INTRODUCTION

11—first wall; 12—second wall; 13—bottom surface; 21—swimming pool cleaning device

### DETAILED DESCRIPTION OF THE INVENTION

The present disclosure is further explained in details below with reference to drawings and embodiments. It should be understood that specific embodiments described here are provided merely for explaining the present disclosure, rather than restricting it. Besides, it should also be explained that the drawings only demonstrate part of structures related to the present disclosure, rather than all of structures for the sake of description.

Before a more detailed discussion of exemplary embodiments, it should be noted that some exemplary embodiments are described as processing or methods in the form of a flowchart. Although respective steps in the flowchart are described as processing in sequence, many steps may be implemented in parallel, concurrently or simultaneously. Besides, the sequence of the respective steps may be rearranged. When the operation is completed, the processing may be terminated. However, additional steps not illustrated in the drawings may also be included. The processing may correspond to a method, a function, a procedure, a subroutine, a sub-computer program and the like.

In addition, terms such as “first” and “second” may describe various directions, actions, steps or elements in the text. However, these directions, actions, steps or elements are not restricted by these terms. These terms are provided only to distinguish a direction, action, step or element from another direction, action, step or element. For example, a first information may serve as a second information without deviating from the scope of the present disclosure. Likewise, the second information also may act as the first information. The first information and the second information are both information, but they are not the same information. The terms such as “first” and “second” should not be interpreted as indicating or suggesting relative importance or implying the number of the denoted technical features. Therefore, a feature defined by “first” and “second” may explicitly or implicitly include one or more of the features. In the description of the present disclosure, “a plurality of” refers to at least two, such as two or three, unless clearly indicated otherwise.

Method embodiments provided in the embodiments of the present disclosure may be executed in a mobile terminal, a computer terminal or a similar computing apparatus. When the method is operated on a mobile terminal as an example, the above mobile terminal may be a cleaning device.

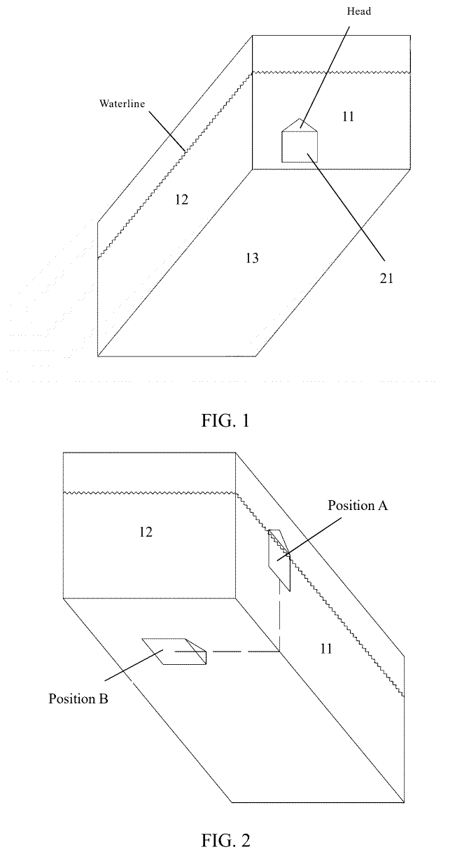

According to a schematic diagram of a swimming pool shown in FIG. 1, in general, a swimming pool includes a bottom surface 13 and a plurality of walls connected with the bottom surface 13. The plurality of walls include a first wall 11 and a second wall 12. The second wall is adjacent to the first wall and is positioned to the right side of the first wall. The swimming pool also includes a swimming pool cleaning device 21. The swimming pool cleaning device includes a head, a left side, a right side, a tail, a bottom and a top. A sewage suction opening is provided at the bottom of the swimming pool cleaning device, and a first drainage outlet, which is connected to the sewage suction opening, is provided at the top of the swimming pool cleaning device. The swimming pool cleaning device sucks the water into the robot through the sewage suction opening at the bottom, filters the water and discharges the water from the first drainage outlet, to complete cleaning of the water in the swimming pool. Besides, the swimming pool cleaning device is also provided with a cleaning rolling brush to clean a position where it travels.

### Embodiment 1

In this embodiment, there is provided a method for controlling a swimming pool cleaning device 21, comprising: monitoring whether the swimming pool cleaning robot traveling on a first wall is close to an obstacle; if the swimming pool cleaning robot is close to the obstacle, controlling the robot to descend to the bottom of the swimming pool; controlling the robot to travel from the bottom of the swimming pool towards a second wall and climb the second wall; wherein in a process of the robot traveling from the bottom of the swimming pool to the second wall and climbing the second wall, the robot approaches the obstacle.

The swimming pool cleaning device 21 cleans a target region on the first wall 11 of the swimming pool, wherein the target area may be a waterline and the target area may also be the entire wall.

For example, in a case of cleaning the waterline, when it is detected that the robot has arrived at the water surface of the swimming pool, the robot is controlled to stay at a water surface position, where the robot has arrived, for a preset duration (such as three seconds) and then the robot is controlled to move along a waterline direction. Since the robot is provided with a cleaning rolling brush, when the robot arrives at the water surface, the cleaning rolling brush at front of the robot is just at the waterline position. In this way, the waterline may be cleaned within the preset duration of the robot's stay.

In a case of cleaning a wall, after a cleaning starting point is selected, the wall is traversed according to a preset cleaning path to complete the cleaning of the wall. Specifically, a regular cleaning path includes N-shaped, bow-shaped, U-shape or Y-shape path, etc. The present disclosure is not specifically restricted in this regard and the choice may be made depending on actual application scenarios.

As shown in FIG. 2, if the swimming pool cleaning robot is close to the obstacle, the robot is controlled to descend to the bottom of the pool. For example, the obstacle is the second wall. When the swimming pool cleaning robot is close to the second wall, it is confirmed that cleaning of the target region of the first wall has been completed and the robot is controlled to move from the first wall to the bottom of the pool.

It should be explained that after completing the cleaning task of the first wall, the robot is required to continue cleaning on the second wall. However, restricted by its movement capability, the robot first needs to move from the first wall to the bottom of the pool and then move from the bottom of the pool to the second wall.

A process of the movement of the robot from position A to position B is to be described in details below. In a case where the robot is on the first wall, the robot is controlled to retreat to the bottom of the first wall. By adjusting operating parameters, e.g., reducing power of a water pump, the robot gradually moves to the bottom surface and continues to retreat a first preset distance d1 to reach the position B, wherein the role of the first preset distance is to ensure that a space is reserved for the robot to perform rotating acts. The first preset distance d1, e.g., 0.1 meters, 0.2 meters and 0.3 meters, etc., may be set according to actual situations,

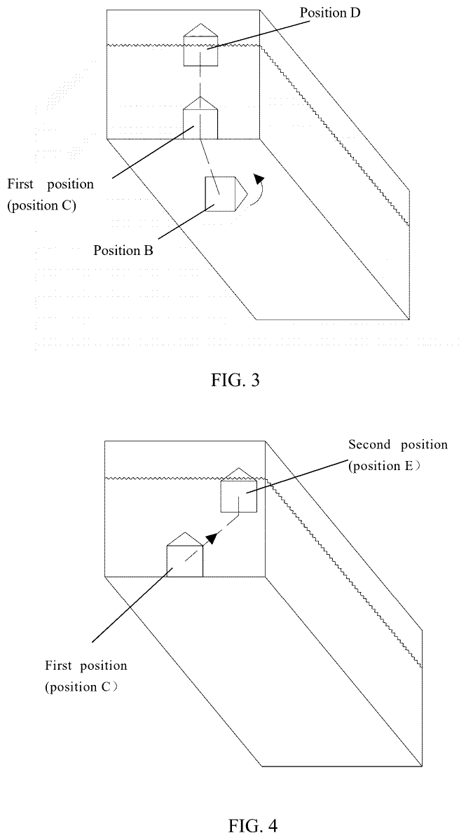

As shown in FIG. 3, after the robot arrives at the position B, the robot is controlled to move towards the second wall from the bottom of the pool and climb the second wall, wherein in the process of moving from the bottom of the pool towards the second wall and climbing the second wall, the robot approaches the obstacle.

Preferably, the step of the robot approaching the obstacle includes controlling a distance between the robot and the obstacle to be between 0 cm and 30 cm.

To be specific, to reduce a sweep missing region on the second wall, it is expected that the robot, before executing the cleaning task, can approach the obstacle as much as possible. To facilitate understanding, it may be deemed that the obstacle in this process is the first wall. The final position of climbing the wall may be considered as a starting point for executing the cleaning task on the second wall and is preferably set near the waterline.

A process of the robot traveling from the bottom of the pool towards the second wall and climbing the second wall is to be described in details below.

Specifically, the step of the robot approaching the obstacle includes: controlling the robot to turn at the bottom of the pool, on the wall or in the waterline region.

In one embodiment, the robot is controlled to turn on the wall.

As shown in FIG. 4, it is assumed that the second wall is positioned at the left side of the first wall. In such case, after arriving at the position B, the robot is controlled to rotate by a first preset angle J1, e.g., rotating to the left by 90 degrees, and move forward a second preset distance d2 to touch the second wall. The second preset distance, e.g., 0.1 meters, 0.2 meters, etc., may be set depending on actual situations. The second preset distance also may be controlled by sensor detection. In a case where the robot has touched the second wall and starts a wall climbing operation, it is detected via a sensor, such as an inertial measurement unit, whether the robot has fully climbed the second wall. In a case where the robot has fully climbed the second wall and has arrived at a position C, a body of the cleaning device, when the cleaning device is at position C, is substantially perpendicular to the waterline and positioned at the bottom of the second wall.

It should be emphasized that in a case where the robot executes a normal cleaning path after climbing the wall in the prior art, the robot would go to position D as shown in FIG. 3, wherein the position D serves as the starting point of the cleaning task. In such case, the robot would only clean a region to the left of the position D, because the robot has retreated the first preset distance at the bottom of the pool, resulting into a sweep missing region in the right-side region of the position D which is not conducive to wall cleaning or waterline cleaning.

Specifically, a cleaning path of the robot for the sweep missing region is to be described in details below.

According to FIG. 4, in a case where the robot is at the position C, the robot is controlled to rotate from the position C by a second preset angle J2, e.g., rotating to the right by 30 degrees, and move a third preset distance d3, such that at least a part of a lateral face of the robot is close to the first wall. It should be noted that in a case where the lateral face of the robot does not touch the first wall, the third preset distance d3 may be a set value, e.g., 0.1 meters, 0.2 meters and the like, or also may be calculated from detecting a distance to the first wall by a detector. In a case where the lateral face of the robot touches the first wall, the third preset distance may be determined by a collision detection. For example, a collision situation is detected by an inertial measurement unit. Then, the robot is controlled to rotate to the left by a third preset angle J3 to be parallel with the first wall and travels up to a position E, wherein the body of the cleaning device, when the cleaning device is at the position E, is substantially perpendicular to the waterline and is closer to the first wall compared to being located at position B or position C.

Specifically, the second preset angle is between 30 and 60 degrees and the third preset distance is a fixed value or determined based on a current distance between the cleaning device and the first wall.

Of course, preferably, the position E is near the waterline of the second wall. It should be noted in a case where the lateral face of the robot touches the first wall, the robot may continue to move forward to be parallel with the first wall due to inertia, without rotating to the left by the third preset angle to achieve the same.

In another embodiment, the robot is controlled to turn in the waterline region.

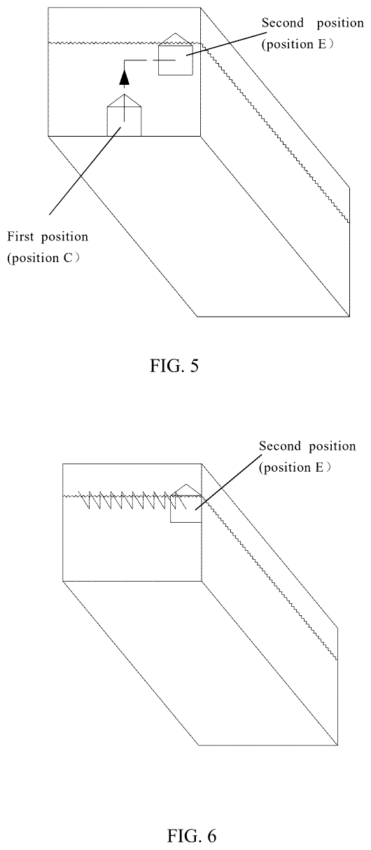

In a case where the position E is near the waterline of the second wall as shown in FIG. 5, the robot, when at the position C, is controlled to move from the position C up to the position D. At this point, the robot is already near the waterline and moves to the right along the waterline direction to the position E.

In a further embodiment, the robot is controlled to turn at the bottom of the pool.

Specifically, the robot is controlled to complete the movement of approaching the first wall at the bottom of the pool. Then, the robot climbs up the second wall to ascend to the position E. In other words, the robot does not need to make a turn along the path to the position E on the second wall.

In this embodiment, it is assumed that the second wall is located to the right of the first wall. In such case, after arriving at the position B, the robot is controlled to rotate by a fourth preset angle J4, e.g., rotating to the left by 45 degrees, and move a fifth preset distance d5 to approach the first wall. The fifth preset distance d5, e.g., 0.1 meters, 0.2 meters and the like, may be set depending on actual situations. Besides, the fifth preset distance may also be controlled by sensor detection. In a case where the robot starts a wall climbing operation after it has touched the second wall, it is detected via a sensor, e.g., an inertial measurement unit, whether the robot has fully climbed up the second wall. If the robot has fully climbed up the second wall, it may continue to ascend to the position E without turning.

It should be explained that the above embodiments just illustrate a possible planning path. Depending on the actual environment, the robot may match a planning path suitable for a current scenario. For example, in case that the robot is unable to turn or understeers due to a current restricted space, or if a distance needed for the planning path is longer than the distance of the actual path, the robot may first choose to retreat a certain distance and then plan a path correspondingly. Other examples will not be listed here one by one.

It should be emphasized that the cleaning device at the position E is much closer to the first wall than the cleaning device at the position B.

Furthermore, the turning action includes rotating by a second preset angle.

Specifically, in a case where the robot is controlled to turn at the bottom of the pool, the second preset angle preferably is between 30 and 60 degrees.

Specifically, in a case where the robot is controlled to turn in a waterline region, the second preset angle is preferably between 20 and 90 degrees.

Specifically, in a case where the robot is controlled to turn in a wall region, the second preset angle is preferably between 20 and 50 degrees.

Moreover, the step of monitoring whether the swimming pool cleaning robot traveling on the first wall is close to the obstacle includes monitoring whether a lateral face of the robot is close to the obstacle.

To be specific, in order to confirm the time when the robot is required to switch to clean another wall, it is needed to detect the environmental conditions on the side of the robot where it is working. For example, when a second wall is detected on the side of the robot, in a case where it is detected that a distance between the swimming pool cleaning robot traveling on the first wall and the obstacle is between 0 cm and 30 cm, the robot executes a wall switching operation.

Moreover, the obstacle includes a corner, a stair in a corner region or an escalator in the corner region. Under these scenarios, the robot will execute the wall switching operation.

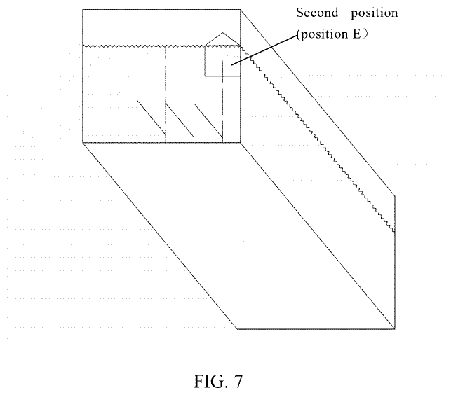

After arriving at the position E, the robot selects a set cleaning path in accordance with the target cleaning region. For example, in a case where the target cleaning region is a waterline region, as shown in FIG. 6, the robot moves laterally to the left from the position E along the waterline direction to complete the waterline cleaning task. In a case where a wall is the target cleaning region to be cleaned, as shown in FIG. 7, the robot executes a wall cleaning path at position E, such as Y-shaped or U-shaped cleaning path.

The cleaning device is controlled to move to the position E as the starting point, which is closer to the first wall in comparison to the position D which is used, in the prior art, as the starting point. Accordingly, the sweep missing region is reduced and the cleaning coverage rate is improved.

### Embodiment 2

In this embodiment, there is provided a computer-readable storage medium, in which computer programs are stored, wherein the computer programs, when executed by a processor, implement steps of the control method according to the first aspect.

### Embodiment 3

In this embodiment, there is provided a swimming pool cleaning robot, comprising: one or more processors; and a memory for storing one or more programs.

The one or more programs, when executed by the one or more processors, cause the one or more processors to implement the method for controlling the swimming pool cleaning device according to the first aspect.

In summary, the present disclosure provides a method for controlling wall cleaning. The cleaning device is controlled to move to a starting point of a cleaning task on the second wall, which is closer to the first wall in comparison to a starting point of a cleaning task used in the prior art. Accordingly, the sweep missing region is reduced and the cleaning coverage rate is improved.

Through the above description of the implementations, those skilled in the art would clearly understand that the present disclosure may be implemented by means of software and essential general hardware, which is a preferred implementation in most cases. Of course, the present disclosure may also be implemented by hardware. Based on such understanding, an essential part of the technical solution of the present disclosure or a part of the technical solution of the present disclosure making contributions to the prior art may be embodied in the form of a software product. The computer software product may be stored in a computer-readable storage medium, such as a floppy disk, a Read-Only Memory (ROM), a Random Access Memory (RAM), a flash, a hard disk or an optical disk etc., and include several instructions to enable a computer device (which may be a personal computer, a server or a network device etc.) to execute the method according to respective embodiments of the present disclosure.

The above described is merely the embodiments of the present disclosure and does not restrict the patent scope of the present disclosure. Equivalent substitutions made using the description and the drawings of the present disclosure or direct or indirect application in the related technical fields are within the patent protection scope of the present disclosure.

1. A control method of a swimming pool cleaning robot, wherein the method comprises:
monitoring whether the swimming pool cleaning robot traveling on a first wall is close to an obstacle;
if the swimming pool cleaning robot is close to the obstacle, controlling the robot to descend to a bottom of a pool;
controlling the robot to move from the bottom of the pool towards a second wall and climb the second wall;
wherein the robot is approaching the obstacle in a process of moving from the bottom of the pool towards the second wall and climbing the second wall.

2. The control method of claim 1, wherein the step of the robot approaching the obstacle comprises controlling the robot to turn at the bottom of the pool, on a wall or in a waterline region.

3. The control method of claim 2, wherein the step of the controlling the robot to descend to the bottom of the pool comprises controlling the robot to advance or retreat to the bottom of the pool and rotate by a first preset angle; wherein the first preset angle preferably is 90 degrees.

4. The control method of claim 2, wherein an action of the turn comprises rotating by a second preset angle.

5. The control method of claim 1, wherein the step of monitoring whether the swimming pool cleaning robot traveling on the first wall is close to the obstacle comprises monitoring whether a lateral face of the robot is close to the obstacle.

6. The control method of claim 1, wherein the step of monitoring whether the swimming pool cleaning robot traveling on the first wall is close to the obstacle comprises monitoring whether a distance between the swimming pool cleaning robot traveling on the first wall and the obstacle is between 0 cm and 30 cm.

7. The control method of claim 6, wherein the obstacle comprises a corner, a stair in a corner region or an escalator in the corner region.

8. The control method of claim 1, wherein the step of the robot approaching the obstacle comprises controlling a distance between the robot and the obstacle to be between 0 cm and 30 cm.

9. A computer-readable storage medium, wherein the computer-readable storage medium is stored with computer programs, and the computer programs, when executed by a processor, implement steps of the method according to claim 1.

10. A swimming pool cleaning robot, comprising a memory, a processor and computer programs stored on the memory and executable by the processor, wherein the processor, when executing the computer programs, implement steps of the method according to claim 1.
